(19) United States
(12) Patent Application Publication
(10) Pub. No.: US 2014/0040521 A1
(43) Pub. Date: Feb. 6, 2014

(54) MEMORY CARD AND CONNECTION SLOT INSERTEDLY PROVIDED THEREOF

(71) Applicant: Innodisk Corporation, New Taipei City (TW)

(72) Inventors: CHIN-CHUNG KUO, NEW TAIPEI CITY (TW); HSIN-JUNG HUNG, NEW TAIPEI CITY (TW)

(73) Assignee: Innodisk Corporation, New Taipei City (TW)

(21) Appl. No.: 13/957,710

(22) Filed: Aug. 2, 2013

Related U.S. Application Data
(60) Provisional application No. 61/679,116, filed on Aug. 3, 2012.
(60) Provisional application No. 61/680,380, filed on Aug. 7, 2012.

(51) Int. Cl. G06F 13/40

(52) U.S. Cl. CPC G06F 13/409
USPC 710/301; 711/115

(57) ABSTRACT

A memory card and a connection slot insertedly provided thereof are proposed. The memory card comprises a plurality of pin holes and the connection slot comprises a plurality of pin headers. The memory card may be inserted into the pin headers of the connection slot by means of the pin holes so as to transmit a specific transfer protocol specification between the memory card and the connection slot. When the pin holes of the memory card is inserted into the pin headers of the connection slot, the contact area between each of pin holes and each of corresponding pin headers can be wider so that the connection between them can be tight and stable, which results in high reliability in the contact between the memory card and the connection slot and thus improves the security in data transmission.

### CROSS-REFERENCES TO RELATED APPLICATIONS

This application claims the benefits of U.S. Provisional Patent Application No. 61/679,116, filed Aug. 3, 2012 and 61/680,380, filed Aug. 7, 2012, the contents of which are incorporated herein by reference in their entirety.

### FIELD OF THE INVENTION

The present invention is related to a memory card and a connection slot insertedly provided thereof, particularly to a memory card capable of inserting into a connection slot by the use of the pin structure.

### BACKGROUND

In accordance with the requirement of storing for the data, currently in electronic device usually can be provided with a connection slot capable for a memory card to be inserted so as to expand the memory capacity of the electronic device.

The conventional memory card and connection slot are connected each other with single-side contact mode, such as the conventional memory card has a single-side electrical contact with a plurality of conduction spring plates of the conventional connection slot by a plurality of gold fingers. However, the connection of the single-side contact mode can easily become loose and unstable due to an external force such that the data transmitted between the conventional memory card and connection slot becomes degraded or uncorrected, thereby affects the reliability of data access.

### SUMMARY OF THE INVENTION

It is one object of the present invention to provide a memory card and a connection slot insertedly provided thereof, in which the memory card comprises a plurality of pin holes and the connection slot comprises a plurality of pin headers, when the pin holes of the memory card is inserted into the pin headers of the connection slot, the contact area between each of pin holes and each of corresponding pin headers can be wider so that the connection between them can be tight and stable, which results in high reliability in the contact between the memory card and the connection slot and thus improves the security in data transmission.

It is one object of the present invention to provide a memory card and a connection slot insertedly provided thereof, in which the connection slot can be provided with various transfer protocol specifications of data pin headers that are defined from the pin headers within the connection slot so that the different transfer protocol specifications of data pin holes of the memory card can be inserted into the connection slot.

To achieve above objects, the present invention provides a memory card, comprising: a controller; a plurality of storage elements, connected to the controller, used for storing data; and a plurality of pin holes, connected to the controller, used for transmitting at least one data conforming to SD transfer protocol specification, CFast transfer protocol specification, MMC transfer protocol specification, MS transfer protocol specification, USB transfer protocol specification, eMMC transfer protocol specification, SATA transfer protocol specification or PCI-E transfer protocol specification.

In one embodiment of the present invention, wherein the shell size of the memory card conforms to SD card hardware standard specification, CFast card hardware standard specification, MMC card hardware standard specification or MS card hardware standard specification.

In one embodiment of the present invention, wherein the pin holes are arranged in a single row form or a double row form.

The present invention further provides a connection slot, insertedly provided for a memory card, the memory card comprising a controller, a plurality of storage elements and a plurality of pin holes, the controller connected to the storage elements and the pin holes, the connection slot comprising: a plurality of pin headers, wherein the memory card is inserted into the pin headers of the connection slot by means of the pin holes, at least one data conforming to SD transfer protocol specification, CFast transfer protocol specification, MMC transfer protocol specification, MS transfer protocol specification, USB transfer protocol specification, eMMC transfer protocol specification, SATA transfer protocol specification or PCI-E transfer protocol specification is transmitted between the pin holes and the pin headers.

In one embodiment of the present invention, wherein the connection slot is disposed on a motherboard having a microprocessor, the microprocessor is connected to the pin headers of the connection slot, when the memory card is inserted into the connection slot, the microprocessor is allowed to access the memory card with respect to the date conforming to SD transfer protocol specification, CFast transfer protocol specification, MMC transfer protocol specification, MS transfer protocol specification, USB transfer protocol specification, eMMC transfer protocol specification, SATA transfer protocol specification or PCI-E transfer protocol specification.

In one embodiment of the present invention, wherein the controller defines a plurality of data pin holes from the pin holes, and the microprocessor defines a plurality of first type of data pin headers and a plurality of second type of data pin headers from the pin headers.

In one embodiment of the present invention, wherein the data pin holes within the memory card are defined by the controller corresponding to the defined position of the first type of data pin headers within the connection slot, when the data pin holes are inserted into the first type of data pin headers, a data conforming to a first type transfer protocol specification is transmitted between the data pin holes and the first type of data pin headers.

In one embodiment of the present invention, wherein the data pin holes within the memory card are defined by the controller corresponding to the defined position of the second type of data pin headers within the connection slot, when the data pin holes are inserted into the second type of data pin headers, a data conforming to a second type transfer protocol specification is transmitted between the data pin holes and the second type of data pin headers.

In one embodiment of the present invention, wherein a plurality of first type of data lines and a plurality of second type of data lines are routed on the motherboard, the first type of data lines are connected between the microprocessor and the first type of data pin headers, the second type of data lines are connected between the microprocessor and the second type of data pin headers.

In one embodiment of the present invention, wherein the pin holes and the pin headers are arranged in a single row form or a double row form.

### BRIEF DESCRIPTION OF DRAWINGS

FIG. 1(A) to FIG. 1(C) are a stereogram appearance diagram, a stereogram perspective diagram and a front view of a memory card according to one embodiment of the present invention.

FIG. 2(A) to FIG. 2(C) are a stereogram appearance diagram, a top view and a front view of a connection slot according to one embodiment of the present invention.

FIG. 3 is a stereogram construction diagram of the memory card and the connection slot insertedly provided thereof according to one embodiment of the present invention.

FIG. 4 is a circuit structure diagram of the memory card and the connection slot insertedly provided thereof according to one embodiment of the present invention.

FIG. 5 shows a single row form in the pin holes within the memory card and the pin headers within the connection slot according to one embodiment of the present invention.

FIG. 6 shows a double row form in the pin holes within the memory card and the pin headers within the connection slot according to another embodiment of the present invention.

FIG. 7 is a stereogram appearance diagram of the memory card at the position before being pushed into the connection slot according to one embodiment of the present invention.

FIG. 8 is a stereogram appearance diagram of the memory card at the position after being pushed into the connection slot according to one embodiment of the present invention.

FIG. 9 is a schematic diagram of a connection slot capable of inserting different transfer protocol specifications of memory cards and the routing between the connection slot and the microprocessor according to one embodiment of the present invention

FIG. 10(A) is a circuit structure diagram of a first type of memory card according to one embodiment of the present invention.

FIG. 10(B) is a circuit structure diagram of a second type of memory card according to one embodiment of the present invention.

### DETAILED DESCRIPTION

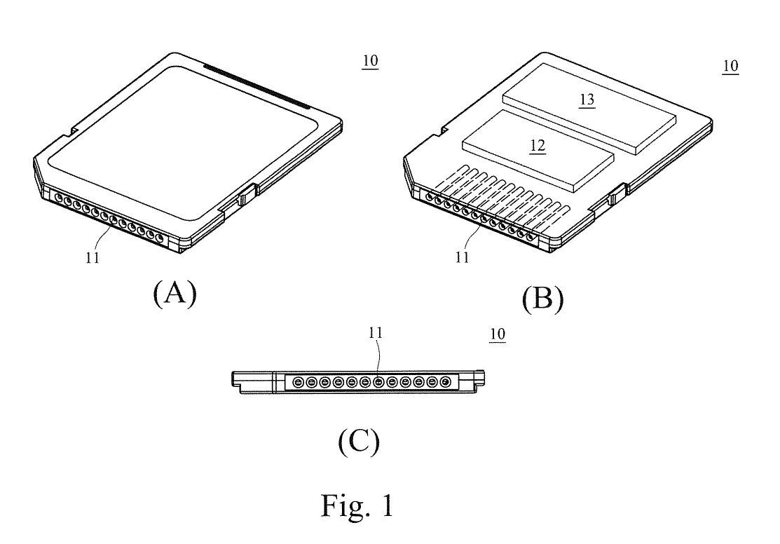

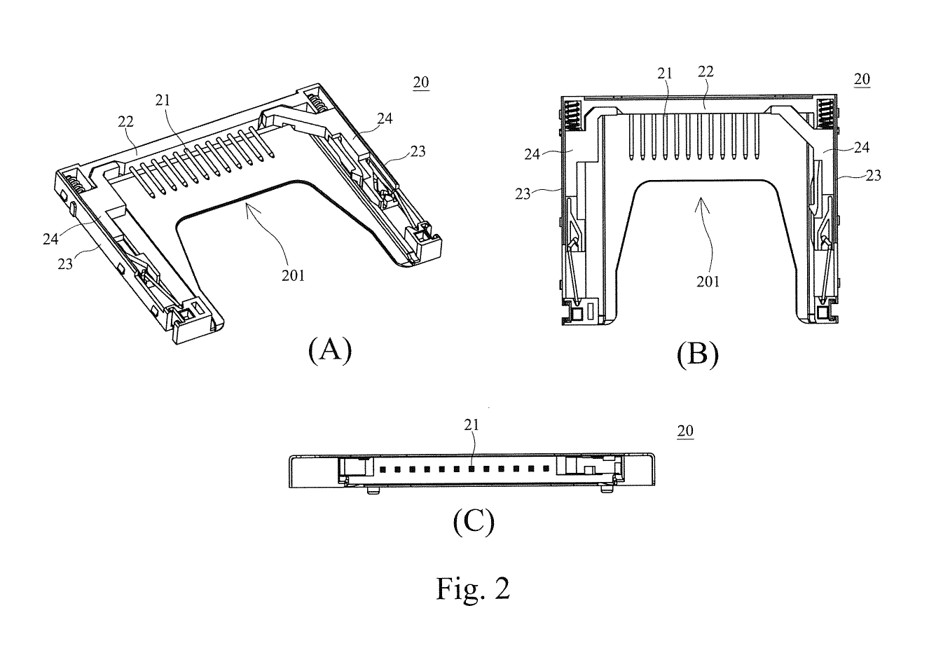

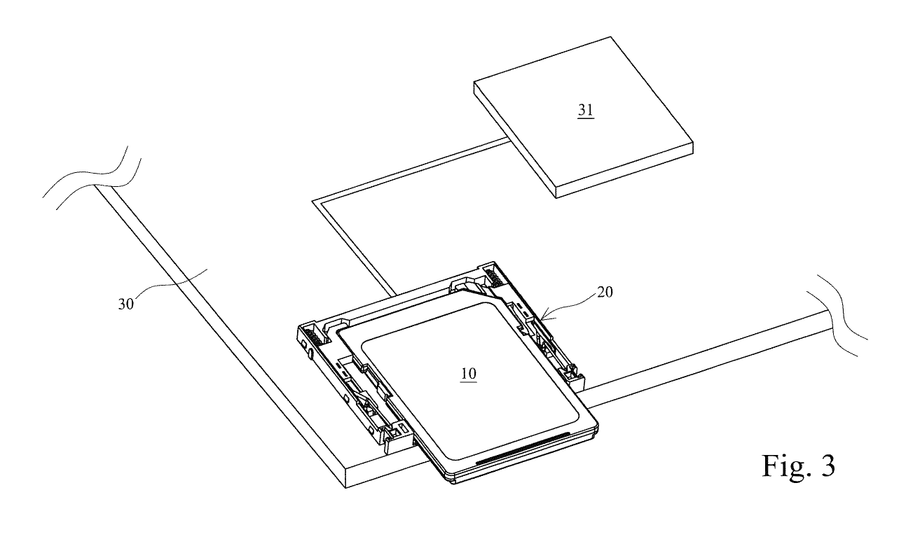

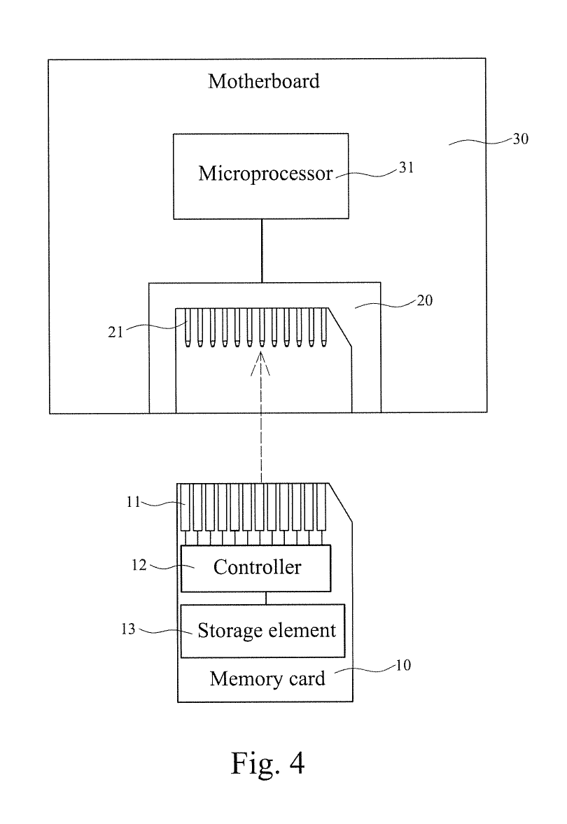

Please refer to FIG. 1(A) to FIG. 1(C) for a stereogram appearance diagram, a stereogram perspective diagram and a front view of a memory card, FIG. 2(A) to FIG. 2(C) for a stereogram appearance diagram, a top view and a front view of a connection slot, as well as FIG. 3 and FIG. 4 for a stereogram construction diagram and a circuit structure diagram of the memory card and the connection slot insertedly provided thereof according to one embodiment of the present invention.

As shown in FIG. 1(A) to FIG. 1(C), the memory card 10 of the present invention comprises a plurality of pin holes 11, a controller 12 and a plurality of storage elements 13. The controller 12 is connected to the pin holes 11 and the storage elements 13, respectively. The storage elements 13 are the flash memories and used for storing data.

The shell size of the memory card 10 of the present invention conforms to SD card hardware standard specification, CFast card hardware standard specification, MMC card hardware standard specification, MS card hardware standard specification or other type card hardware standard specification. Besides, the controller 12 of the memory card 10 is able to transmit at least one data conforming to SD (Secure Digital Memory Card) transfer protocol specification, Cfast (Compact Flash Fast Card) transfer protocol specification, MMC (Multi Media Card) transfer protocol specification, MS (Memory Stick) transfer protocol specification, USB (Universal Serial Bus) transfer protocol specification, eMMC (embedded Multi Media Card) transfer protocol specification, SATA (Serial Advanced Technology Attachment) transfer protocol specification or PCI-E (Personal Computer Interface Express) transfer protocol specification by means of the pin holes 11.

As shown in FIG. 2(A) to FIG. 2(C), FIG. 3 and FIG. 4, the connection slot 20 of the present invention comprises a plurality of pin headers 21, which is provided on a motherboard 30 of an electronic device (such as, computer, mobile phone, and portable electronic product, for example). The motherboard 30 further comprises a microprocessor 31. The pin headers 21 of the connection slot 20 are electrically connected to the microprocessor 31.

The memory card 10 of the present invention is inserted into the pin headers 21 of the connection slot 20 by means of the pin holes 11, in such a way that the microprocessor 31 of the motherboard 30 is allowed to access the memory card 10 with respect to at least one data conforming to SD, CFast, MMC, MS, USB, eMMC, SATA or PCI-E transfer protocol specification through the inserted connection between the pin holes 11 and the pin headers 21.

As such, when the pin holes 11 of the memory card 10 is inserted into the pin headers 21 of the connection slot 20, the contact area between each of pin holes 11 and each of corresponding pin headers 21 can be wider so that the connection between them can be tight and stable, which results in high reliability in the contact between the memory card 10 and the connection slot 20.

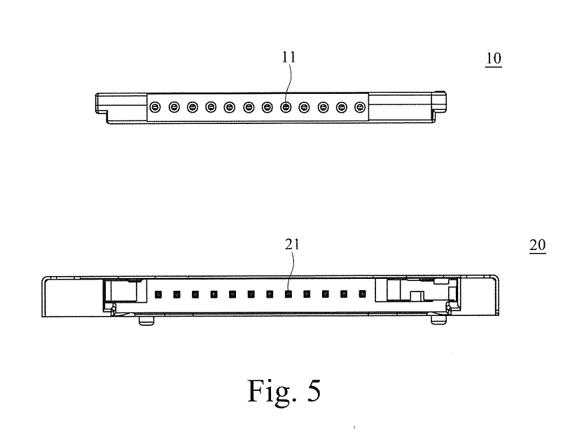

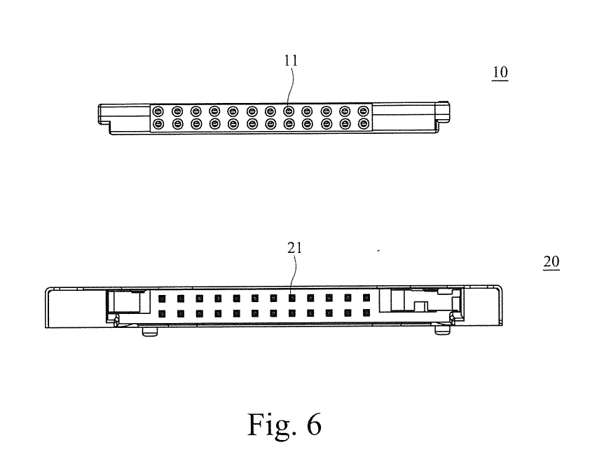

Furthermore, in one embodiment of the present invention, the pin holes 11 of the memory card 10 and the pin headers 21 of the connection slot 20 are arranged in a single row form, as shown in FIG. 5. Otherwise, in another embodiment of the present invention, the pin holes 11 of the memory card 10 and the pin headers 21 of the connection slot 20 are arranged in a double row form, as shown in FIG. 6.

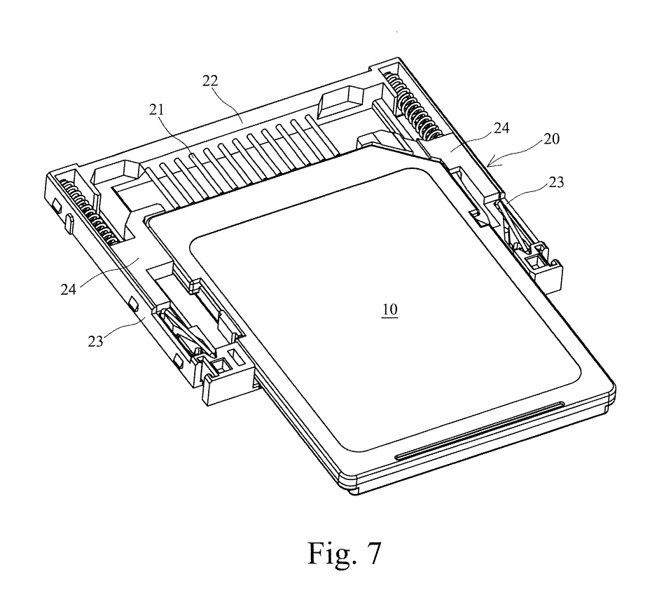

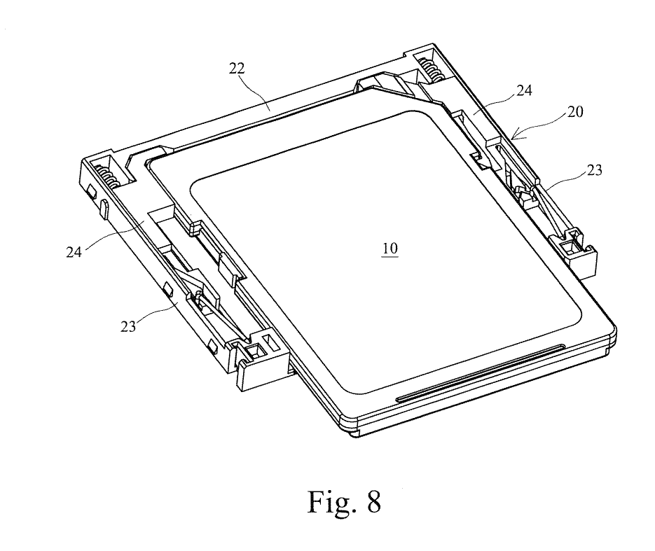

Please refer to FIG. 7 for a stereogram appearance diagram of the memory card at the position before being pushed into the connection slot and FIG. 8 for a stereogram appearance diagram of the memory card at the position after being pushed into the connection slot according to one embodiment of the present invention, as well as simultaneously refer to FIG. 2(A) to FIG. 2(C). The housing structure of the connection slot 20 comprises a base 22 and two arms 23. Two arms 23 configure on the both side of the base 22, respectively. A card capacity area 201 is formed between the base and the arms 23. The pin headers 21 are fixed to the base 22 and protruded in the card capacity area 201. The memory card 10 is able to pass in or out the connection slot 20 from the card capacity area 201.

In the present invention, one of arms 23 may be provided with a card ejecting mechanism 24, or two arms 23 may be separately provided with a card ejecting mechanism 24.

As shown in FIG. 7, when the memory card 10 is desired to push into the connection slot 20, the user presses the bottom of the memory card 10 to move forward so that the card ejecting mechanism 24 is able to approach the base 22 by the pushing of the top of the memory card 10. Subsequently, as shown in FIG. 8, when the card ejecting mechanism 24 has pushed to the side of the base 22, the memory card 10 can be fixed within the card capacity area 201 through the card ejecting mechanism 24, and the pin holes 11 of the memory card 10 are inserted into the pin headers 21 of the connection slot 20. Thus, the microprocessor 31 of the motherboard 31 is able to access the memory card 10 with respect to the data conforming to a specific transfer protocol specification through the inserted between the pin holes 11 and the pin headers 21.

Further, returning to FIG. 7, when the memory card 10 is desired to eject from the connection slot 20, the user again presses the bottom of the memory card 10 to move forward so that the card ejecting mechanism 24 is able to withdraw from the side of the base 22 and guide the memory card 10 to move backward. At this present, the pin holes 11 of the memory card 10 are separate from the pin headers 21 of the connection slot 20. Thus, the memory card 10 is able to eject and withdraw from the card capacity area 201 of the connection slot 20.

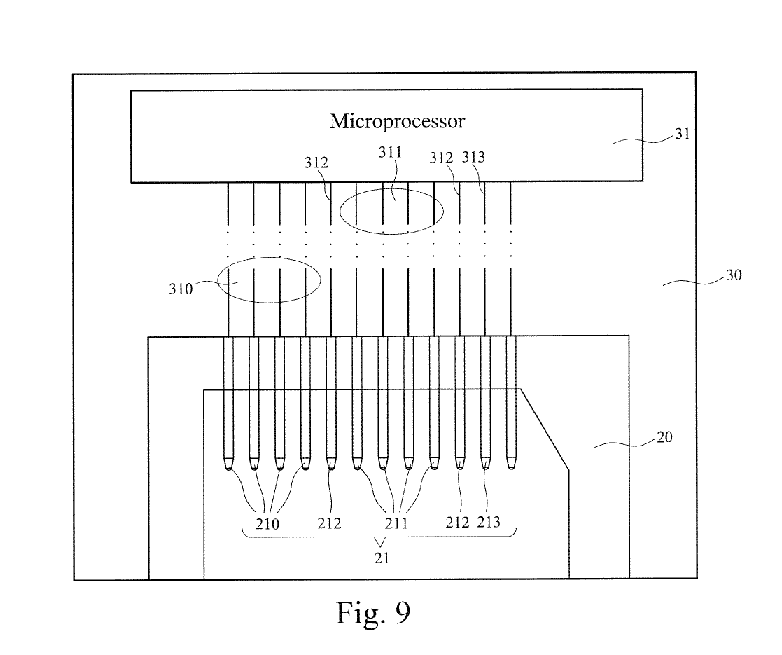

Please refer to FIG. 9 for a schematic diagram of a connection slot capable of inserting different transfer protocol specifications of memory cards and the routing between the connection slot and the microprocessor according to one embodiment of the present invention. As shown in figures, the connection slot 20 comprises a plurality of pin headers 21. The microprocessor 31 defines a plurality of first type of data pin headers 210, a plurality of second type of data pin headers 211, at least one ground pin header 212 and at least one power pin header 213 from these pin headers 21. A plurality of first type of data lines 310, a plurality of second type of data lines 311, at least one ground line 312 and at least one power line 313 are routed on the motherboard 30. The first type of data lines 310 are connected between the microprocessor 31 and the first type of data pin headers 210, the second type of data lines 311 are connected between the microprocessor 31 and the second type of data pin headers 211, the ground line 312 is connected between the microprocessor 31 and the ground pin header 212, and the power line 313 is connected between the microprocessor 31 and the power pin header 213.

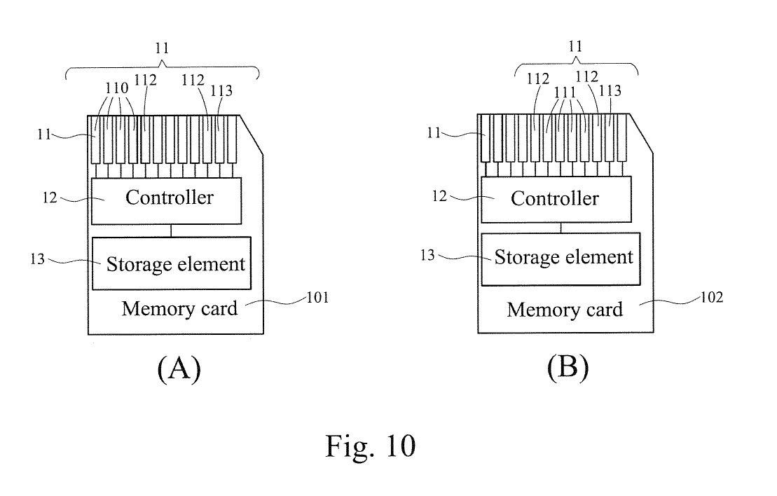

Please refer to FIG. 10(A) for a circuit structure diagram of a first type of memory card according to one embodiment of the present invention. The memory card 101 of the present embodiment is a memory card conforming to a first type transfer protocol specification (such as SD, Cfast, MMC or MS type transfer protocol specification, for example). The memory card 101 comprises a plurality of pin holes 11. The controller 12 defines a plurality of data pin holes 110, at least one ground pin hole 112 and at least one power pin hole 113 from these pin holes 11. In the present embodiment, the data pin holes 110, the ground pin hole 112 and the power pin hole 113 are defined by the controller 12 corresponding to the defined position of the first type of data pin headers 210, the ground pin header 212 and the power pin header 213 within the connection slot 20.

When the memory card 101 is inserted into the connection slot 20, the data pin holes 110, the ground pin hole 112 and the power pin hole 113 may be inserted into the corresponding first type of data pin headers 210, the corresponding ground pin header 212 and the corresponding power pin header 213, respectively. Thus, the microprocessor 31 of the motherboard 31 is able to access the memory card 101 with respect to the data conforming to the first type transfer protocol specification through the inserted between the data pin holes 110 and the first type of data pin headers 210.

Otherwise, please refer to FIG. 10(B) for a circuit structure diagram of a second type of memory card according to one embodiment of the present invention. The memory card 102 of the present embodiment is a memory card conforming to a second type transfer protocol specification (such USB, eMMC, SATA or PCI-E type transfer protocol specification, for example). The memory card 102 comprises a plurality of pin holes 11. The controller 12 defines a plurality of data pin holes 111, at least one ground pin hole 112 and at least one power pin hole 113 from these pin holes 11. In the present embodiment, the data pin holes 111, the ground pin hole 112 and the power pin hole 113 are defined by the controller 12 corresponding to the defined position of the second type of data pin headers 211, the ground pin header 212 and the power pin header 213 within the connection slot 20.

When the memory card 102 is inserted into the connection slot 20, the data pin holes 111, the ground pin hole 112 and the power pin hole 113 may be inserted into the corresponding second type of data pin headers 211, the corresponding ground pin header 212 and the corresponding power pin header 213, respectively. Thus, the microprocessor 31 of the motherboard 31 is able to access the memory card 102 with respect to the data conforming to the second type transfer protocol specification through the inserted between the data pin holes 111 and the second type of data pin headers 211.

The connection slot 20 of the present invention can be provided with various transfer protocol specifications of data pin headers 210, 211 so that the different transfer protocol specifications of data pin holes 110, 111 of the memory cards 101, 102 can be inserted into the connection slot 20. As such, the motherboard 30 is able to selectivity insert a memory card 101 conforming to a first type transfer protocol specification or a memory card 102 conforming to a second type transfer protocol specification by the use of single connection slot 20, which results in reduced the element cost of the motherboard 30 used in data transfer.

The foregoing description is merely one embodiment of the present invention and not considered as restrictive. All equivalent variations and modifications in shape, structure, feature, and spirit in accordance with the appended claims may be made without in any way from the scope of the invention.

1. A memory card, comprising:
a controller;
a plurality of storage elements, connected to said controller, used for storing data; and
a plurality of pin holes, connected to said controller, used for transmitting at least one data conforming to SD transfer protocol specification, CFast transfer protocol specification, MMC transfer protocol specification, MS transfer protocol specification, USB transfer protocol specification, eMMC transfer protocol specification, SATA transfer protocol specification or PCI-E transfer protocol specification.

2. The memory card according to claim 1, wherein the shell size of said memory card conforms to SD card hardware standard specification, CFast card hardware standard specification, MMC card hardware standard specification or MS card hardware standard specification.

3. The memory card according to claim 1, wherein said pin holes are arranged in a single row form or a double row form.

4. A connection slot, insertedly provided for a memory card, said memory card comprising a controller, a plurality of storage elements and a plurality of pin holes, said controller connected to said storage elements and said pin holes, said connection slot comprising:
a plurality of pin headers, wherein said memory card is inserted into said pin headers of said connection slot by means of said pin holes, at least one data conforming to SD transfer protocol specification, CFast transfer protocol specification, MMC transfer protocol specification, MS transfer protocol specification, USB transfer protocol specification, eMMC transfer protocol specification, SATA transfer protocol specification or PCI-E transfer protocol specification is transmitted between said pin holes and said pin headers.

5. The connection slot according to claim 4, wherein said connection slot is disposed on a motherboard having a microprocessor, said microprocessor is connected to said pin headers of said connection slot, when said memory card is inserted into said connection slot, said microprocessor is allowed to access said memory card with respect to the date conforming to SD transfer protocol specification, CFast transfer protocol specification, MMC transfer protocol specification, MS transfer protocol specification, USB transfer protocol specification, eMMC transfer protocol specification, SATA transfer protocol specification or PCI-E transfer protocol specification.

6. The connection slot according to claim 5, wherein said controller defines a plurality of data pin holes from said pin holes, and said microprocessor defines a plurality of first type of data pin headers and a plurality of second type of data pin headers from said pin headers.

7. The connection slot according to claim 6, wherein said data pin holes within said memory card are defined by said controller corresponding to the defined position of said first type of data pin headers within said connection slot, when said data pin holes are inserted into said first type of data pin headers, a data conforming to a first type transfer protocol specification is transmitted between said data pin holes and said first type of data pin headers.

8. The connection slot according to claim 6, wherein said data pin holes within said memory card are defined by said controller corresponding to the defined position of said second type of data pin headers within said connection slot, when said data pin holes are inserted into said second type of data pin headers, a data conforming to a second type transfer protocol specification is transmitted between said data pin holes and said second type of data pin headers.

9. The connection slot according to claim 6, wherein a plurality of first type of data lines and a plurality of second type of data lines are routed on said motherboard, said first type of data lines are connected between said microprocessor and said first type of data pin headers, said second type of data lines are connected between said microprocessor and said second type of data pin headers.

10. The connection slot according to claim 4, wherein said pin holes and said pin headers are arranged in a single row form or a double row form.
